(19) United States
(12) Patent Application Publication
(10) Pub. No.: US 2026/0218403 A1
(43) Pub. Date: Jul. 30, 2026

(54) LAYOUT OF HYDROGEN AND OXYGEN MANUFACTURING PLANT USING HYDROGEN AND OXYGEN PRODUCTION CELLS

(71) Applicant: Kodzo Obed Abledu, Monrovia, CA (US)

(72) Inventor: Kodzo Obed Abledu, Monrovia, CA (US)

(21) Appl. No.: 19/041,860

(22) Filed: Jan. 30, 2025

(51) Int. Cl. C25B 15/08; B01D 47/02; C25B 9/70

(52) U.S. Cl. CPC C25B 15/085; B01D 47/021; C25B 9/70

(57) ABSTRACT

An ion separator is used to produce a stream of positively charged electrolytes and another stream of negatively charged electrolytes with adequate potential difference between the two streams. Short-circuiting these two streams in gas generation chambers produces hydrogen and oxygen gases. This setup of equipment is assembled as a containerized hydrogen and oxygen production cell. An x-y grid layout of many containerized hydrogen and oxygen production cells is used to outline a scalable plant for manufacturing oxygen and green hydrogen in large quantities.

### RELATED APPLICATION

This application is a Non-provisional Application of Provisional Application Ser. No. 63/626,853 for “Layout of Hydrogen and Oxygen Manufacturing Plant Using Hydrogen and Oxygen Production Cells” filed on 30 Jan. 2024.

### BACKGROUND OF THE INVENTION

The present invention relates to the manufacturing of hydrogen and oxygen gases using hydrogen and oxygen production cells. Hydrogen is much needed during the current energy transition for different industrial purposes and as an energy carrier. The need for hydrogen manufacturing from water by electrical means, the so-called green hydrogen, has increased recently as industry seeks to move away from other methods that produce greenhouse gases. This invention is directed to solve this problem and introduce a novel electrical method to use in manufacturing both hydrogen and oxygen from water.

### SUMMARY OF THE INVENTION

The present invention contrives to solve the disadvantages of prior art.

An aspect of the invention provides an ion separator unit comprising an ion separator device and a motor that drives it. The ion separator unit has two input ports on an input side and three output ports on an output side. These ports are used for electrolytes and are configured for easy coupling to pipes and hoses. The ion separator device has four magnetic poles spatially arranged around a horizontal stator cylinder with two magnetic poles on a left side and the other two magnetic poles on a right side. The four magnetic poles are also arranged such that two magnetic poles are on an upper side of the stator cylinder and another two magnetic poles are on a lower side of the stator cylinder.

There is a magnetic block between the two magnetic poles on the upper side of the stator cylinder and another magnetic block between the two poles on the lower side of the stator cylinder. (This magnetic block could be either magnetic steel or a permanent magnet depending on the preferred excitation.) The two adjacent magnetic poles and the magnetic block on the upper side of the stator cylinder are mounted on a common plate and they form a magnetic circuit on the upper side of the stator cylinder with return path through two air gaps and a rotor structure inside the stator cylinder. Another magnetic circuit is formed on the lower side of the stator cylinder by two magnetic poles on the lower side of the stator cylinder and the magnetic block between them with return path through two other air gaps near the lower side of the stator cylinder and through the rotor structure inside the cylinder. The two magnetic circuits are such that they make the two magnetic poles on the left side of the stator cylinder to have the same polarity (say, north pole) and the two poles on the right side of the stator cylinder also have the same but opposite polarity (say, south pole). Angled structures are firmly attached to the magnetic poles on both the upper side and the lower side of the stator cylinder, and these angled structures are bolted together to prevent the magnetic poles from detaching and falling apart when the magnetic circuit is energized.

The ion separator unit receives two input streams of electrolytes through the two input ports and as the motor runs, it produces two charged output streams of electrolytes. A negatively charged output stream of electrolytes comes out of the middle port on the output side and positively charged output streams of electrolytes come out of the two outer ports on the output side. A potential difference exists between the positively charged output streams of electrolytes and the negatively charged output stream of electrolytes.

Gas generation chambers built with stainless steel are used to generate hydrogen and oxygen gases. The gas generation chambers work in pairs. There is an electrical connection between each pair and the two gas generation chambers in the pair carry electrolytes of opposite charges with adequate potential difference between the electrolytes.

When charged electrolytes are pumped into the pair of gas generation chambers, the electrolytes are partially discharged inside the chamber to generate either hydrogen or oxygen. (Hydrogen is generated in the positively charged electrolyte and oxygen in the negatively charged electrolyte.) The partially discharged electrolyte comes out of one output pipe and the generated gas comes out of another pipe. The gas generation chamber has one or more ribs fabricated into its outer shell for extra strength. The gas generation chamber has two slots near the bottom for bringing out electrical connections from the bottom. It also has four pairs of holes on a top plate for bracing one unit to other units and to steady structures to prevent toppling over during severe earthquakes.

The inner parts of the gas generation chamber comprise several arrays of perforated stainless steel sheet metal fabricated on a base plate; and also a polymer tube with a U-bend in it. This polymer tube is epoxied into an output pipe that carries electrolytes out of the gas generation chamber. This polymer tube forms the inlet of the output pipe and makes the electrolyte leaving the gas generation chamber to initially go down a long U portion of the tube before coming up into the output pipe located near an upper side of the gas generation chamber. This prevents gas bubbles in the electrolyte from going down to reach the bottom of the U-bend in the polymer tube and stops gas from coming out of the output pipe with the electrolytes. The gas generated in the gas generation chambers bubble to the top of the electrolyte and accumulate on top of both the electrolyte and the perforated stainless steel sheet metal arrays inside the gas generation chamber thus pressurizing the gas generation chamber; and the gas will only come out through another pipe located at the very top of the gas generation chamber above the reach of the electrolytes.

Mists and droplets containing electrolytes would accompany any gas coming out of the gas generation chambers and the electrolytes must be removed to clean the gas. A gas scrubber is used to remove electrolytes from the gas. The gas scrubber comprises a flanged inlet gas pipe and a flanged outlet gas pipe. The gas scrubber also has an inlet water pipe and an outlet water pipe. It has a pair of opposite slots at a lower end for strapping the gas scrubber to where it is mounted. Bracing holes are provided on an upper plate for securely attaching the upper plate to other study structures.

The inner parts of a lower portion of the gas scrubber consist of an inlet gas pipe that has a perforated cup as its opening into a scrubber chamber. The perforated cup injects gas both vertically and radially into the water that partially fills the scrubber chamber. Strips of perforated sheet metal welded to a nearby vertical plate in a zigzag fashion, with the strips located above the perforated cup, further break the gas injected into the water into bubbles as the gas zigzags upwards through the strips of perforated sheet metal. The water in the scrubber chamber gets “dirtier” as it removes the impurities from the gas going through.

The “dirtier” water is removed from the scrubber chamber as additional “cleaner” water is sent into the scrubber chamber through an inlet water pipe and delivered near a top portion of the scrubber chamber above the strips of perforated sheet metal. This water replaces the “dirtier” water below it as the “dirtier” water makes its way around the vertical plate and leaves the scrubber chamber from a bottom spout where an output water pipe connects.

A complementary pipe is attached to the scrubber to form one stage of an assembled scrubbing unit. To use this one stage of the assembled scrubbing unit to clean the gas, a lower U-shaped portion of the assembled scrubbing unit is first filled with distilled water. (The water level comes up to the bottom spout of the output pipe located on a bottom surface of the scrubber chamber.) The gas to be scrubbed would flow from the complementary pipe into the scrubber and the gas would push the water in the lower U-shaped portion into the scrubber chamber; and the gas would continue to stream through the perforated cup on its way into the water. The additional “cleaner” water entering the scrubber would flow in the opposite direction—into the input water pipe and be delivered into the scrubber chamber as described earlier on and replace “dirtier” water exiting from the bottom of the scrubber chamber. This will scrub the mist and droplets from the gas and make it cleaner as it comes out of the flanged outlet gas pipe. Several stages of scrubbing will yield clean gas for drying.

In a multi-stage scrubber system, the gas being scrubbed would flow from left to right through the larger pipes and scrubbers. The additional “cleaner” water injected into the scrubber would be pumped from right to left through smaller pipes near a lower portion of the scrubber setup. Positive displacement pumps are used to move the water from one stage to the next at the same flow rate through the scrubbers. In the multi-stage scrubber system, the additional “cleaner” water first enters the right-most stage as purely distilled water, and it exits the scrubber unit from the leftmost stage carrying the electrolyte that is scrubbed from the gas. This additional “cleaner” water would be used to replenish electrolyte tanks that feed the ion separators, thus returning to service any salts that would have escaped. This makes it very convenient and economical. The water for scrubbing is not thrown away, and there is no need to add any external salt to maintain electrolyte concentration levels.

Hydrogen and oxygen production cells are used to make hydrogen and oxygen gases. A hydrogen and oxygen production cell comprises a main electrolyte tank at one end of a setup and the tank is partially filled or replenished with electrolyte. A stream of electrolyte is pumped out of the main electrolyte tank by a pump into an ion separator at another end of the hydrogen and oxygen production cell. The ion separator, driven by an attached motor, produces positively charged electrolyte streams and sends them into a positive electrolyte tank. The ion separator also sends a stream of negatively charged electrolytes into a negative electrolyte tank. (An appropriate voltage is generated between the positively charged electrolyte and the negatively charged electrolyte.) The positively charged electrolyte is pumped from the positive electrolyte tank into the inlet of a first gas generation chamber on a first side (a right side) of the hydrogen and oxygen production cell, and negatively charged electrolyte is pumped from the negative electrolyte tank into a first gas generation chamber on a second side (a left side) of the hydrogen and oxygen production cell. Two first-stage pumps are used to accomplish the electrolyte pumping at this first stage—one pump per side.

At a first discharge stage, the charged electrolytes in the first gas generation chamber on the right side and the first gas generation chamber on the left side are short-circuited by metallic paths between the two gas generation chambers. Hydrogen is produced in the first gas generation chamber on the right side (a hydrogen side) and oxygen is produced in the first gas generation chamber on the left side. The hydrogen gas is sent into a hydrogen feeder pipe. Similarly, the oxygen generated in the first gas generation chamber is sent into an oxygen feeder pipe. The positively charged electrolyte pumped into the first gas generation chamber on the right side gets partially discharged and comes out from an output pipe and goes into a second-stage pump to initiate a second stage of discharge to produce more hydrogen from this second stage. A similar process takes place on the left side (an oxygen side) of the hydrogen and oxygen production cell to produce more oxygen at a second stage. This process carries on through all the four stages until both the positively charged electrolyte and the negatively charged electrolyte are fully, or almost fully discharged. (There could be as many discharge stages as needed instead of the four stages used here.) The discharged electrolytes are then pumped back into the main electrolyte tank through pipes on the hydrogen side, and through other pipes on the oxygen side of the hydrogen and oxygen production cell. These return pipes carry their contents through “pressure-reducing-and-back-pressure-sustaining” valves on both sides before emptying the contents into the main electrolyte tank.

Bracing straps are used to electrically and structurally connect the gas generation chambers together to provide short circuits between the gas generation chambers and to prevent them from toppling over in earthquakes.

The components of the hydrogen and oxygen production cell can be easily scaled, simplified and containerized. For example, the gas generation chamber can be enlarged (made taller); and the two separate gas generation chambers that were short-circuited by external metallic paths can be combined into two chambers built (back-to-back) on a common base plate thus permanently providing a conduction path between the two gas generation chambers and making them into one single physical unit. A containerized version of a hydrogen and oxygen production cell is assembled in which further simplification is implemented by pumping the charged electrolytes from the ion separator directly into the gas generation chambers, thereby using only two electrolyte tanks instead of three.

In the containerized hydrogen and oxygen production cell a common output pipe is connected to all the hydrogen output ports of the gas generation chambers. Similarly, another common output pipe is connected to all the oxygen output ports of the gas generation chambers. These common output pipes equalize the pressures in the gas generation chambers thus preventing a situation where extremely higher pressures are produced in gas generation chambers at earlier stages of discharge while other gas generation chambers at latter stages of discharge have much lower pressures.

The pumps that circulate the electrolytes in the containerized hydrogen and oxygen production cell are built from kits and all the pump heads are insulated from the chassis on which the kits are assembled. This is to prevent short circuiting the electrolytes going through the pump heads. A short circuit of the electrolytes in the pump heads would cause hydrogen and oxygen gases to be generated inside the pump heads. Insulating the pump heads ensures that gases are only generated inside the gas generation chambers which are designed to handle the mixture of electrolytes and gases. The electrolyte pumps are all ganged together into a first set of pumps and are driven by one motor on the hydrogen side of the containerized hydrogen and oxygen production cell. Belt drives from a common shaft connected to the motor drive all the pump heads at the same speed.

There are more components including “pressure-reducing-back-pressure-maintaining valves” placed in the return paths of the discharged electrolytes going back into the two tanks, and a pressure release valve located on each common output pipe of the gas generation chambers in the containerized hydrogen and oxygen production cell. The water that replenishes the two electrolyte tanks of the containerized hydrogen and oxygen production cell enters through a flowmeter which controls its flowrate.

Pumps that circulate electrolytes on the oxygen side are similarly ganged together with pumps that feed electrolytes into the ion separator. Another motor drives this second set of ganged pumps. The motors of both sets of ganged pumps are driven by a common adjustable-speed-drive. And this adjustable speed drive controls the power requirements of the containerized hydrogen and oxygen production cell by the rate at which it pumps electrolytes through the containerized hydrogen and oxygen production cell for processing. A faster speed leads to higher flow rate of electrolytes into the ion separator resulting in higher power usage by all motors and eventually, higher output rates of hydrogen and oxygen production. A slower speed would produce the opposite effect. This feature can be used to control the total power required by any number of containerized hydrogen and oxygen production cells operating in parallel in a factory. A total factory load could be made to follow an available generated power by using the latter to determine the pumping rates of all the ganged pumps. This would be ideal for following renewable energy sources by adjusting the loading to match the available power all done in real time.

A scalable and expandable layout of a hydrogen and oxygen manufacturing plant featuring many containerized hydrogen and oxygen production cells is outlined as the factory floor plan for manufacturing hydrogen and oxygen on a large scale. In this factory floor plan, two large pipes run in the middle of the floor in the y-direction. The two large pipes are: a large left pipe that carries oxygen and a large right pipe that carries hydrogen. Several containerized hydrogen and oxygen production cells are placed in-line in the x-direction on both sides of the two large pipes with their common output pipes connected to hydrogen feeder pipes on either sides of the two large pipes. The hydrogen feeder pipes send the hydrogen produced into the large right pipe via special pigtail connectors that are used to connect the hydrogen feeder pipes to the large right pipe. This is done for both sides of the two large pipes. A similar connection scheme is implemented for the oxygen sides (of the containerized hydrogen and oxygen production cells) involving the common output pipes, oxygen feeder pipes and the large left pipe. This forms the first row of the factory floor. Arrays of these connections are built along the length of the two large pipes to form an x-y grid of containerized hydrogen and oxygen production cells, with all the hydrogen feeder pipes and sending the hydrogen gas generated into the large right pipe and all the oxygen feeder pipes sending the oxygen gas generated into the large left pipe.

The large left pipe and the large right pipe send their gases through scrubbers. Scrubbed hydrogen gas goes through a hydrogen dryer, a hydrogen compressor, and is then packaged into a hydrogen cylinder. Scrubbed oxygen gas goes through an oxygen dryer, oxygen compressor, and is then packaged into an oxygen cylinder.

Two adjacent containerized hydrogen and oxygen production cells are placed very close to each other to enhance the utilization of factory floor space. The manufacturing plant floor layout can be expanded to produce more hydrogen and oxygen by increasing the number of rows and columns. The capacity of the layout is also scalable by increasing the sizes and capacities of the components. The water for scrubbing and replenishing the tanks on the containerized hydrogen and oxygen production cells comes from a main water tank outside the main factory floor and this water is first used in scrubbing the gases and then stored in a smaller tank from which it is pumped to all the containerized hydrogen and oxygen production cells on the factory floor.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view of the input side of an ion separator unit according to an embodiment of the invention;

FIG. 2 is a perspective view of the output side of an ion separator unit according to an embodiment of the invention;

FIG. 3 is a perspective view of a partial inner portion of the ion separator unit from the input side with two horizontal support plates on an upper side and a vertical support plate on a right end side and other parts suppressed according to an embodiment of the invention;

FIG. 4 is a perspective view of a partial inner portion of the ion separator unit from the output side with two horizontal support plates on an upper side and a vertical support plate on a left end side and other parts suppressed according to an embodiment of the invention;

FIG. 5 is a perspective view of a gas generation chamber according to an embodiment of the invention;

FIG. 6 is a perspective view of perforated stainless steel sheet metal arrays inside the gas generation chamber according to an embodiment of the invention;

FIG. 7 is a perspective view of an output electrolyte pipe location and perforated stainless-steel arrays inside the gas generation chamber according to an embodiment of the invention;

FIG. 8 is a perspective view of a gas scrubber according to an embodiment of the invention;

FIG. 9 is a perspective view of a lower portion and inner composition of the gas scrubber according to an embodiment of the invention;

FIG. 10 is a perspective view of a lower portion of the scrubber showing both the water inlet point, delivery point, and outlet point according to an embodiment of the invention;

FIG. 11 is a perspective view of one stage of an assembled scrubbing unit according to an embodiment of the invention;

FIG. 12 is a side view of a section of a multi-stage scrubber according to an embodiment of the invention;

FIG. 13 is a top view of a hydrogen and oxygen production cell according to an embodiment of the invention;

FIG. 14 is a perspective view of a hydrogen and oxygen production cell according to an embodiment of the invention;

FIG. 15 is a partially expanded perspective view of a hydrogen and oxygen production cell according to an embodiment of the invention;

FIG. 16 is a perspective view of scaled and short-circuited two gas generation chambers built back-to-back on the same base plate according to an embodiment of the invention;

FIG. 17 is a perspective view of a containerized hydrogen and oxygen production cell showing hydrogen gas generating side according to an embodiment of the invention;

FIG. 18 is a perspective view of an expanded middle portion of FIG. 17 according to an embodiment of the invention;

FIG. 19 is a view of a containerized hydrogen and oxygen production cell showing an oxygen side according to an embodiment of the invention;

FIG. 20 is a perspective view of a manufacturing plant layout featuring many pairs of hydrogen and oxygen production cells according to an embodiment of the invention; and

FIG. 21 is a top view of a manufacturing plant layout featuring many pairs of hydrogen and oxygen production cells according to an embodiment of the invention.

### DETAILED DESCRIPTION, EMBODIMENTS OF THE INVENTION

The U.S. Provisional Patent Application No. 63/626,853 for “Layout of Hydrogen and Oxygen Manufacturing Plant Using Hydrogen and Oxygen Production Cells” filed on 30 Jan. 2024 is incorporated by reference herein for any and all purposes.

Referring to the figures, the embodiments of the invention are described in detail.

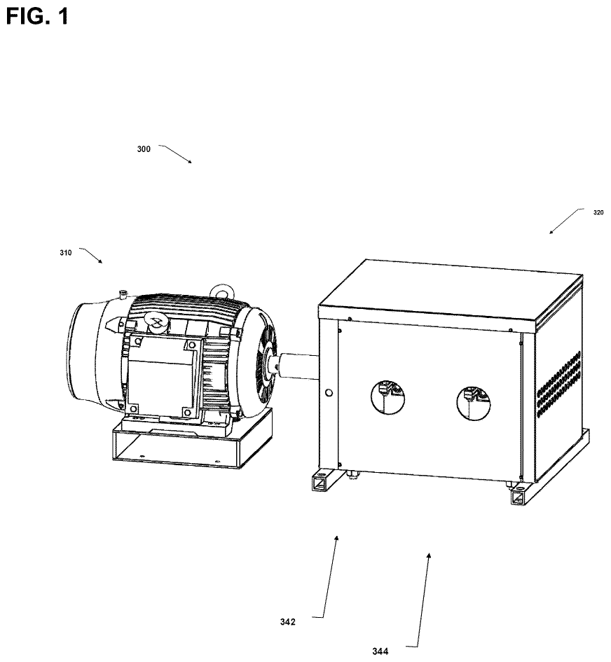

FIG. 1 shows an ion separator unit 300 comprising a drive motor 310 and an ion separator 320. The ion separator 320 has two input ports 342, and 344 on an input side.

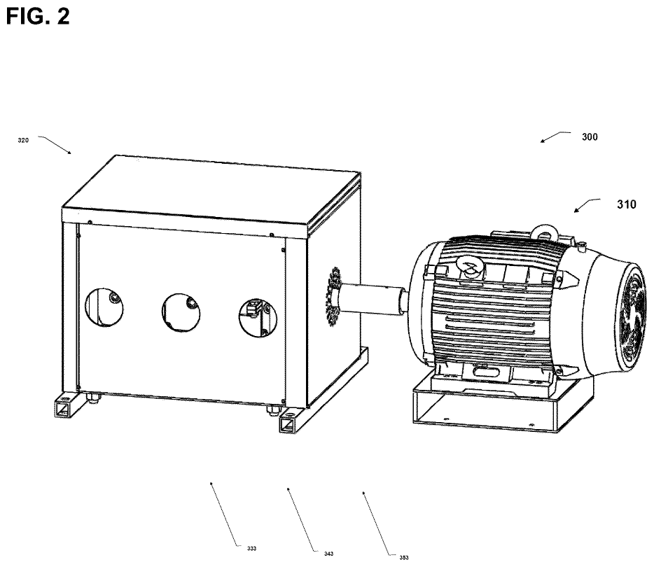

FIG. 2 shows an output side of the same ion separator unit 300 comprising a drive motor 310 and an ion separator 320. The ion separator 320 has three output ports 333, 343, and 353 on an output side.

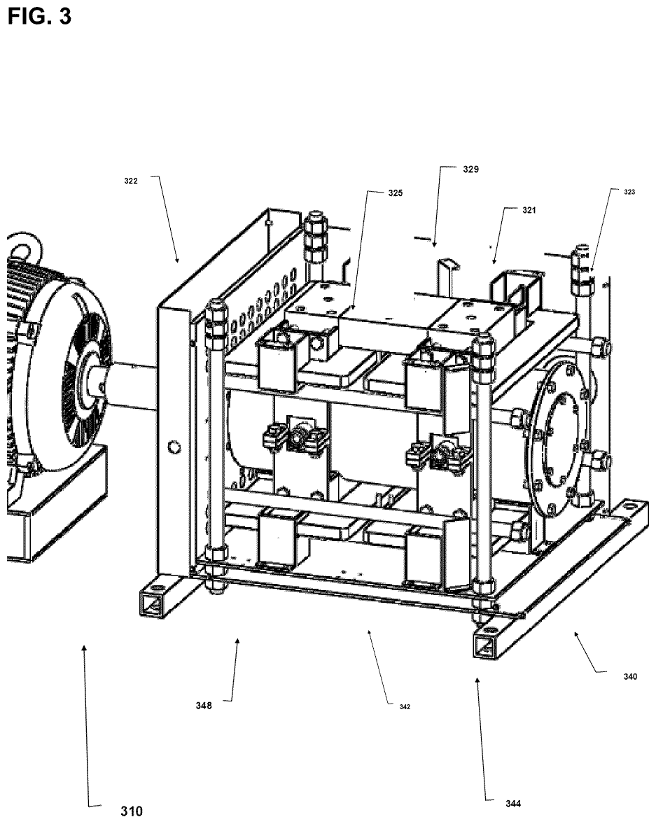

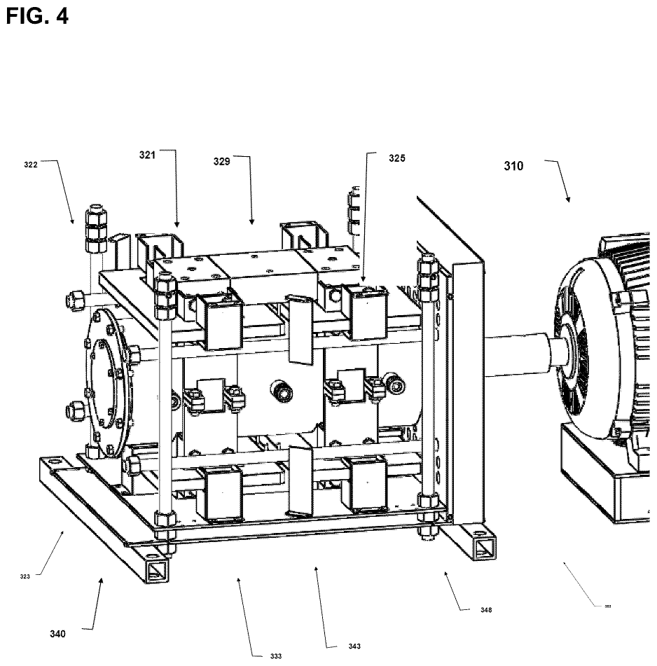

FIG. 3 and FIG. 4 show the inner parts of an ion separator and how magnetic poles are supported inside the ion separator 320. (One such pole is labeled 321.) There are four magnetic poles around a stator cylinder 323. Two magnetic poles are located on an upper side of the stator cylinder 323 and another two are located on a lower side of the stator cylinder 323. There is a magnetic block 329 between any two adjacent magnetic poles. (This magnetic block could be either magnetic steel or a permanent magnet depending on the preferred excitation.) The two adjacent magnetic poles and the magnetic block 329 are mounted on a common plate 340. The common plate 340 for the two magnetic poles on the lower side of the stator cylinder 323 is shown but the other one on the upper side is suppressed in the drawings. All components and structures around the stator cylinder 323 are symmetric on the lower and upper sides of the stator cylinder 323.

Other structural components around the stator cylinder 323 have been suppressed to clearly show the magnetic poles and angled structures 325 bolted unto each magnetic pole to ensure that the weight of the magnetic pole is not borne by the stator cylinder 323 but by the angled structures 325 bolted to the magnetic poles. The designs and spacings of the angled structures 325 provide clearances in the structures for the connection spouts (of ports 342, and 344 in FIG. 3; and 333, 343, and 353 in FIG. 4) built into the stator cylinder 323 to be accessible for use. On either the input or output side of the ion separator, there is a separate angled structure attached to each magnetic pole located on an upper side of the stator cylinder; and these angled structures sit on another set of angled structures that are attached to another magnetic pole located on a lower side of the stator cylinder 323. (The magnetic poles snugly fit into the stator cylinder.) Bolting these two structures together, as shown in FIG. 3 and FIG. 4, prevents the magnetic poles from pushing apart or detaching from the stator cylinder 323 when the magnetizing coils 322 are energized. There is one magnetizing coil per magnetic pole. The magnetizing coils are supported in place by multiple plastic structures 348 mounted on plate 340.

The ion separator receives two input streams of electrolytes through the two input ports 342 and 344 shown in FIG. 3; and as the motor 310 runs, it produces two charged output streams of electrolytes. A negatively charged output stream of electrolytes comes out of the middle port 343 on the output side and positively charged output streams of electrolytes come out of the two outer ports 333, and 353 on the output side. A potential difference exists between the positively charged output stream of electrolytes and the negatively charged output stream of electrolytes.

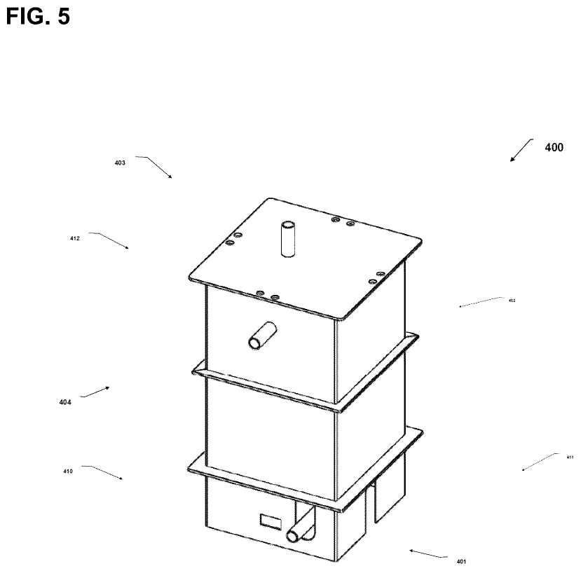

FIG. 5 shows a drawing of a gas generation chamber 400 built with stainless steel. The gas generation chambers work in pairs. There is an electrical connection between each pair and the two gas generation chambers in the pair carry electrolytes of opposite charges with adequate potential difference between the electrolytes. When charged electrolytes are pumped through the input pipe 401 into the pair of gas generation chambers, the electrolytes are partially discharged inside the chamber to generate either hydrogen or oxygen depending on the polarity of the electrolyte. (Hydrogen is generated in the positively charged electrolyte and oxygen in the negatively charged electrolyte.) The partially discharged electrolyte comes out of output pipe 402 and the generated gas comes out of pipe 403. The gas generation chamber 400 has one or more ribs 404 fabricated into its outer shell for extra strength. It also has two opposite slots 410, for strapping it to where it would be mounted. Two other slots 411, located near a bottom and also opposite each other are provided for bringing out electrical connections from the bottom. Four pairs of holes 412 are also provided on a top plate for bracing one unit to other units and to steady structures to prevent toppling over during severe earthquakes.

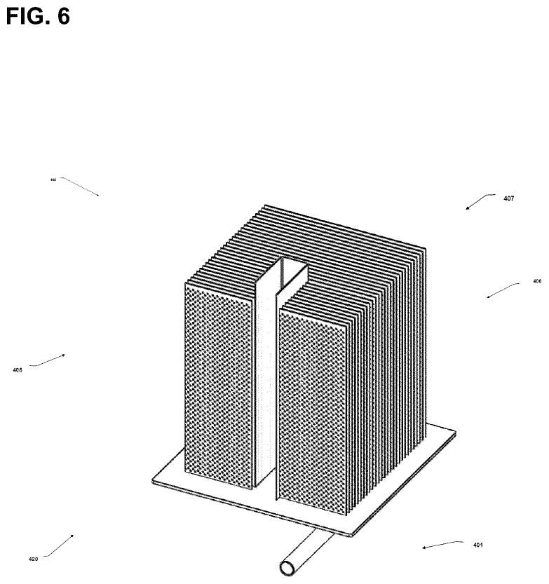

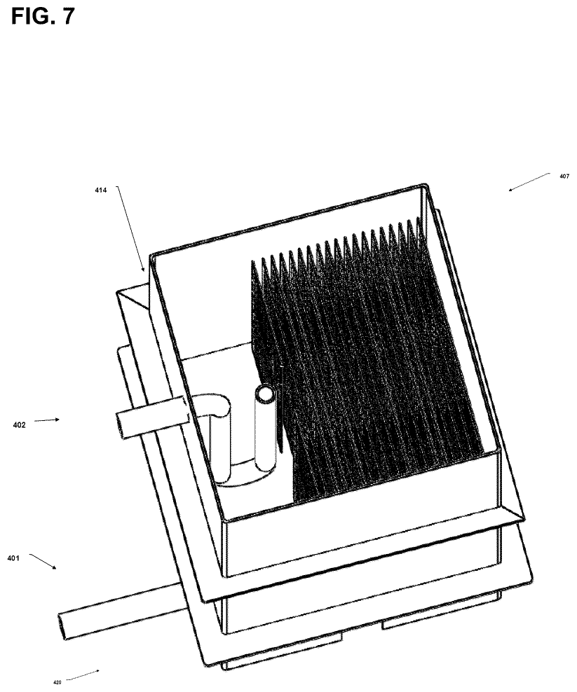

The inner parts of the gas generation chamber are shown in FIG. 6 and FIG. 7. There are several arrays of perforated stainless steel sheet metal fabricated on a base plate 420 in FIG. 6. Two arrays in front, 405 and 406, are separated by a gap between them. This gap is fitted with channel 408.

A top portion of the gas generation chamber is removed in FIG. 7 to show a view of the inside. A polymer tube 414 with a U-bend in it is epoxied into the output pipe 402 from inside the chamber. This polymer tube 414 is the inlet of the output pipe 402 and the polymer tube fits into channel 408 (shown in FIG. 6) when the gas generation chamber is assembled. The channel 408, and the two front arrays, 405 and 406, shown in FIG. 6 are suppressed in FIG. 7 to clearly show the polymer tube 414. The U-bend in the polymer tube 414 prevents gas bubbles from going down to reach the bottom of the U-bend and this stops gas from coming out of the output pipe 402. The generated gas will bubble to the top of the electrolyte and remain on top of both the electrolyte and the perforated stainless steel sheet metal arrays inside the gas generation chamber 400; the gas will pressurize the gas generation chamber 400 and only come out through pipe 403 (shown in FIG. 5).

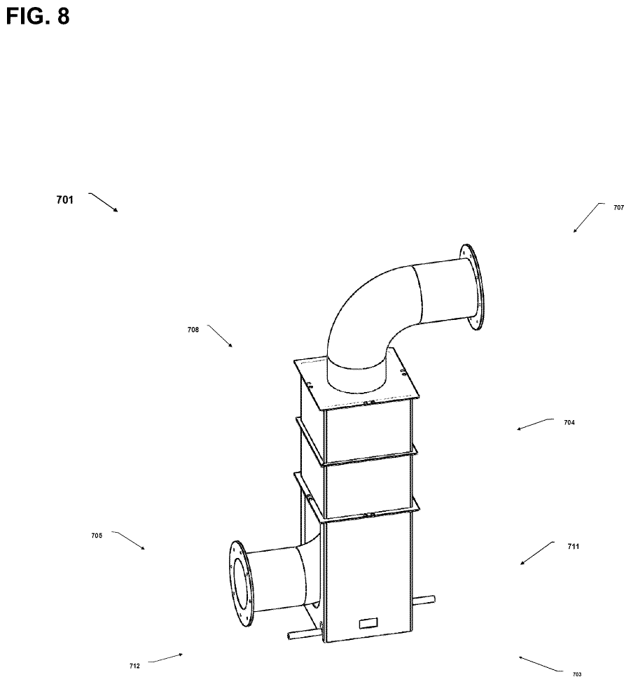

Mists and droplets containing electrolytes would accompany any gases coming out of the gas generation chambers and the electrolytes must be removed to clean the gases. A gas scrubber is used to clean the gas. FIG. 8 shows a gas scrubber 701 comprising a flanged inlet gas pipe 705 and a flanged outlet gas pipe 707. The gas scrubber 701 also has an inlet water pipe 711 and an outlet water pipe 712. A pair of opposite slots 703 at a lower end is for strapping the gas scrubber 701 to where it is mounted. Bracing holes 708 are provided on an upper plate for securely attaching the plate to other study structures.

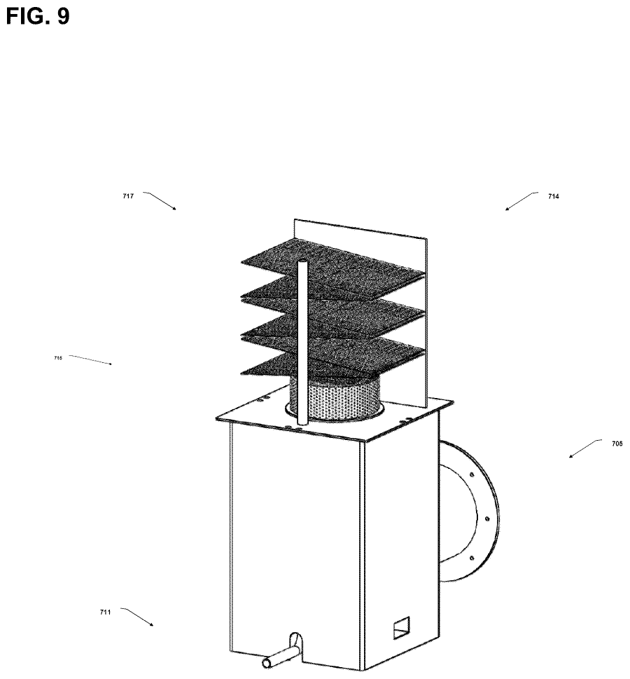

FIG. 9 shows a lower portion and an arrangement of parts inside the gas scrubber. The inlet gas pipe 705 has a perforated cup 715 as its opening into a scrubber chamber. The perforated cup 715 would inject gas both vertically and radially into the water that partially fills the scrubber chamber. Strips of perforated sheet metal 717, welded to plate 714, and located above the perforated cup 715 would further break the gas injected into the water into bubbles as the gas zigzags upwards through the strips of perforated sheet metal 717. The water in the scrubber chamber gets “dirtier” as it removes the impurities from the gas going through.

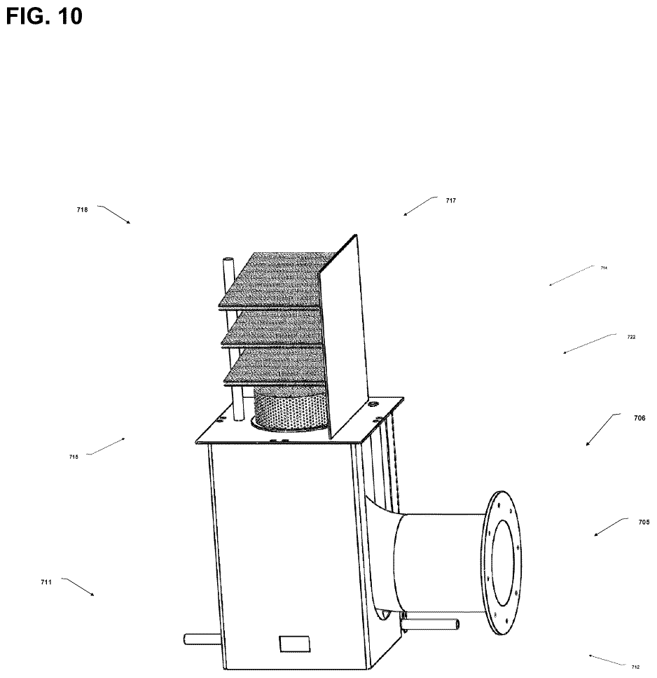

FIG. 10 illustrates how the “dirtier” water is removed from the scrubber chamber. Additional “cleaner” water is sent into the scrubber 701 through the inlet water pipe 711 and delivered near a top portion 718 of the inlet water pipe. The delivery point is above the strips of perforated sheet metal 717. This water replaces the “dirtier” water below it as the “dirtier” water makes its way around the plate 714 and leaves the scrubber chamber from a bottom spout 722 where the output water pipe 712 connects.

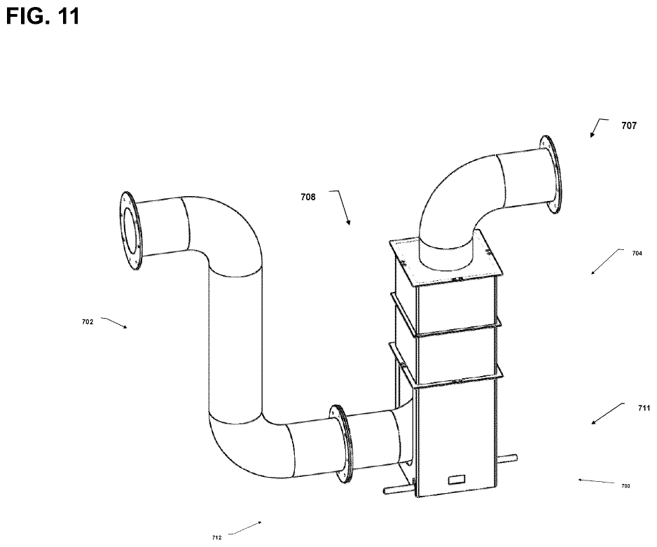

FIG. 11 shows a complementary pipe 702 that is attached to scrubber 701 to form one stage of an assembled scrubbing unit. To use this one stage of the assembled scrubbing unit to clean the gas, a lower U-shaped portion of the assembled scrubbing unit is first filled with distilled water. (The water level comes up to the bottom spout 722 shown in FIG. 10.) The gas to be scrubbed would be flowing from pipe 702 into the scrubber (from left to right in FIG. 11) and the gas would push the water in the lower U-shaped portion into the scrubber chamber; and the gas would continue to stream through the perforated cup 715 on its way into the water. The additional “cleaner” water entering the scrubber would flow in the opposite direction-into the input water pipe 711 and be delivered into the scrubber chamber as described earlier on and replace “dirtier” water exiting pipe 712. This will scrub the mist and droplets from the gas and make it cleaner as it comes out of the flanged outlet gas pipe 707. Several stages of scrubbing will yield clean gas for drying.

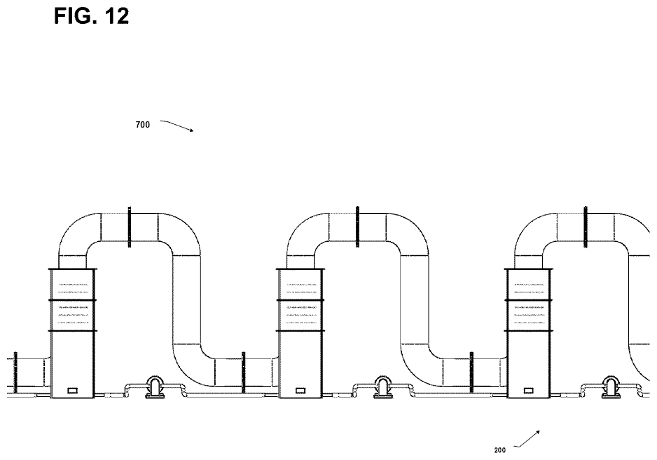

FIG. 12 shows a section 700 of a multi-stage scrubber system. The gas being scrubbed would flow from left to right through the larger pipes and scrubbers. The additional “cleaner” water injected into the scrubber would be pumped from right to left through the smaller pipes shown near a lower portion of the drawing. Positive displacement pumps 200 are used to move the water from one stage to the next at the same flow rate through the scrubbers. In the multi-stage scrubber system, the additional “cleaner” water first enters the right-most stage as purely distilled water, and it exits the scrubber unit from the leftmost stage carrying the electrolyte that is scrubbed from the gas. This additional “cleaner” water would be used to replenish electrolyte tanks that feed the ion separators, thus returning to service any salts that would have escaped. This makes it very convenient and economical. The water for scrubbing is not thrown away, and there is no need to add any external salt to maintain electrolyte concentration levels.

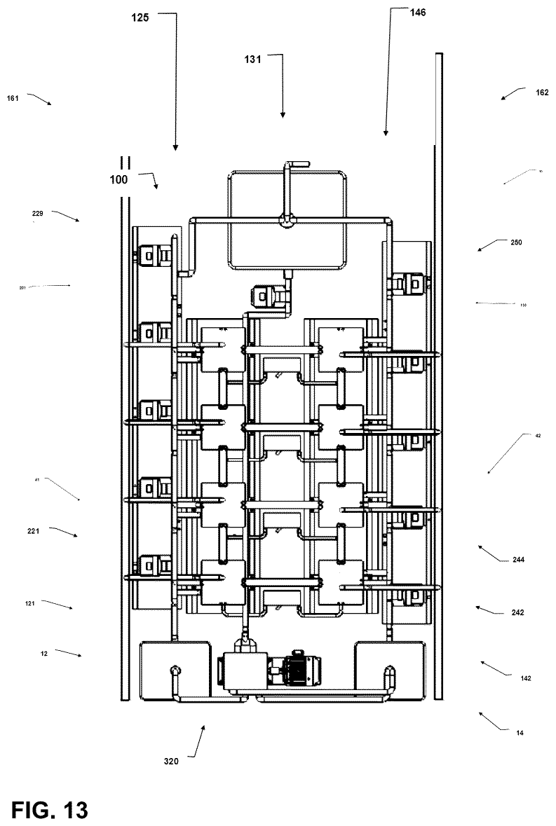

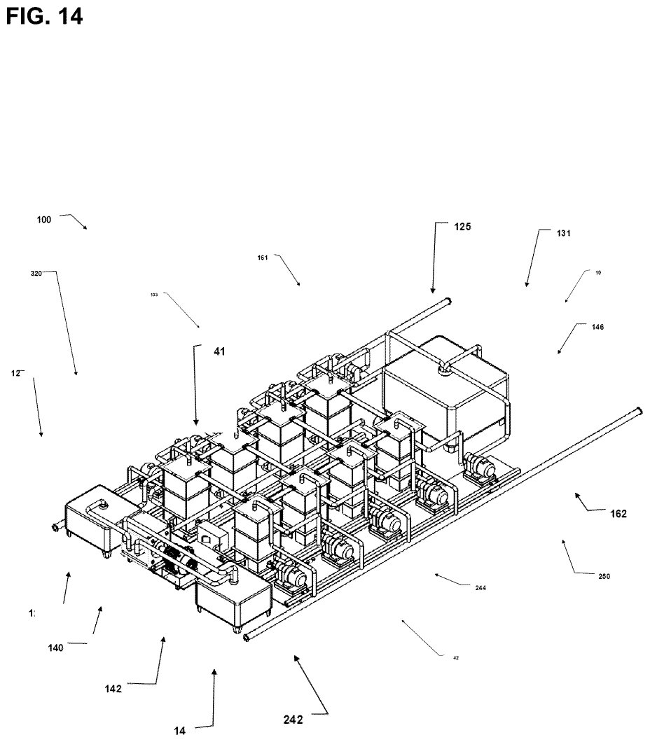

FIG. 13 shows a top view of a hydrogen and oxygen production cell 100 and FIG. 14 shows a perspective view of the same. A main electrolyte tank 10, at one end of the hydrogen and oxygen production cell, is partially filled or replenished with electrolyte via pipe 131. A stream of electrolytes is pumped out of the main electrolyte tank 10 by pump 201 through pipe 133 into an ion separator 320 at another end of the hydrogen and oxygen production cell 100. The ion separator 320 driven by an attached motor produces positively charged electrolyte streams and sends them through pipes 140 and 142 into a positive electrolyte tank 14. The ion separator also sends a stream of negatively charged electrolytes through pipe 120 into negative electrolyte tank 12. (An appropriate voltage is generated between the positively charged electrolytes and the negatively charged electrolytes.) Pump 242 pumps positively charged electrolytes from the positive electrolyte tank 14 via pipe 192 and pushes it into the inlet of the gas generation chamber 42, and pump 221 pumps negatively charged electrolytes from the negative electrolyte tank 12 via pipe 121 and sends it into the gas generation chamber 41. These can be more clearly seen in FIG. 13.

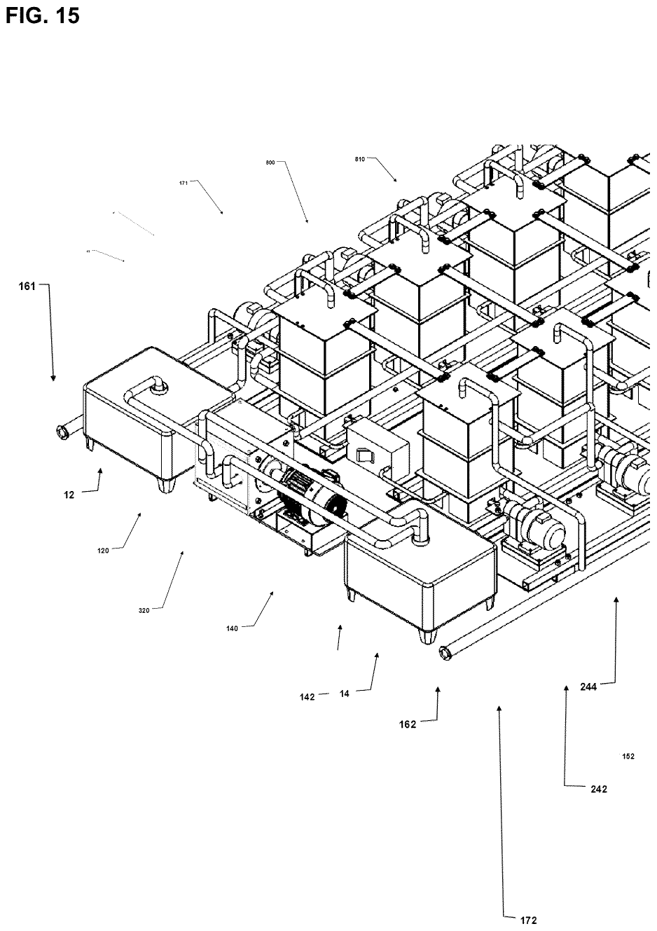

We now continue the description of the operation using FIG. 15, which is a partially enlarged portion of FIG. 14. At a first discharge stage, the charged electrolytes in the gas generation chambers 41 and 42 are short-circuited by metallic strap 800 and other metallic paths between the two gas generation chambers. Hydrogen is produced in gas generation chamber 42 and oxygen is produced in gas generation chamber 41. The hydrogen gas comes out of hose 172 and goes into hydrogen feeder pipe 162. Similarly, the oxygen generated in gas generation chamber 41 comes out of hose 171 and goes into an oxygen feeder pipe 161. The positively charged electrolyte pumped into the gas generation chamber 42 gets partially discharged and comes out through pipe 152 and goes into pump 244 to initiate a second stage of discharge to produce more hydrogen from this second stage. A similar process takes place on an oxygen side of the hydrogen and oxygen production cell to produce more oxygen at a second stage. This process carries on through all the four stages shown in FIG. 13 and FIG. 14 until both the positively charged electrolyte and the negatively charged electrolyte are fully, or almost fully discharged. (There could be as many stages as needed instead of the four stages used here.) The discharged electrolytes are then pumped back into the main electrolyte tank 10 by pump 250 (shown in FIG. 13 and FIG. 14) through pipe 146 on a positively charged electrolyte side (a hydrogen side), and by pump 229 (more clearly shown in FIG. 13) through pipe 125 on a negatively charged electrolyte side (an oxygen side). Pipe 146 carries its contents through a “pressure-reducing-and-back-pressure-sustaining” valve (not shown in drawings) before emptying into the main electrolyte tank 10. Pipe 125 also carries its contents through another similar valve (also not shown in drawings) before emptying into main electrolyte tank 10. Bracing straps 800 and 810 electrically and structurally connect the gas generation chambers together to provide short circuit between the gas generation chambers and to prevent them from toppling over in earthquakes.

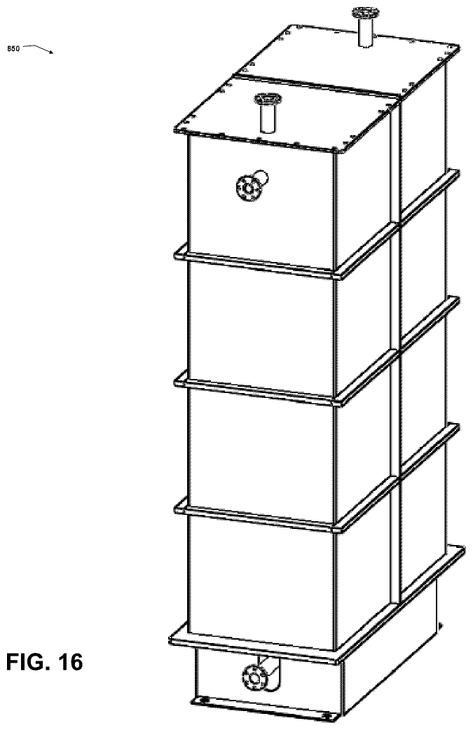

The components of the hydrogen and oxygen production cell can be easily scaled and simplified. FIG. 16 shows a new gas generation chamber 850 that has been enlarged (made taller); and the two separate gas generation chambers that were short-circuited by external bars have been combined into two chambers built (back-to-back) on a common base plate thus permanently providing a conduction path between the two gas generation chambers and making them into one single physical unit.

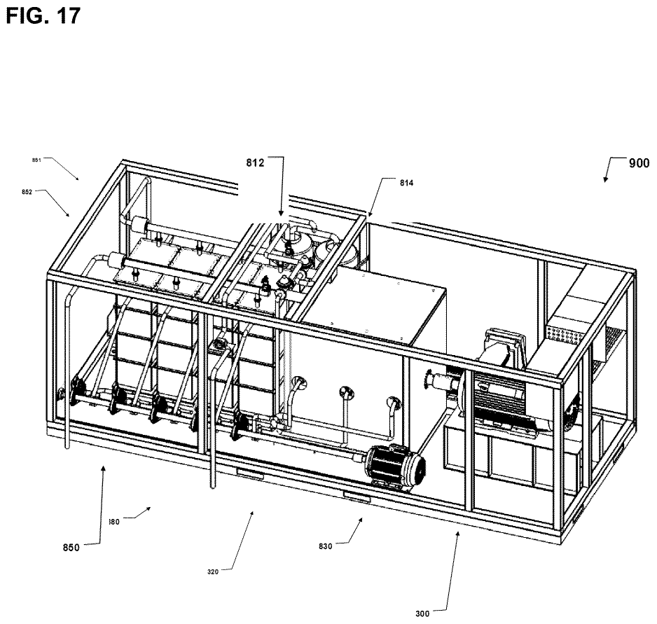

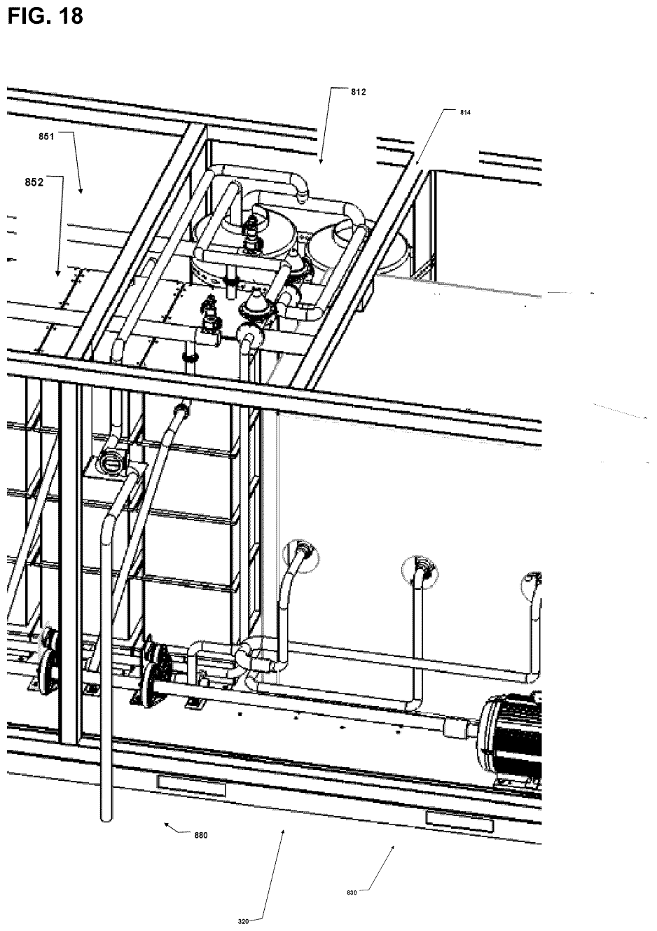

FIG. 17 is a containerized hydrogen and oxygen production cell 900. FIG. 18 is an expanded view of part of FIG. 17. Both FIG. 17 and FIG. 18 show how further simplification is implemented by pumping the charged electrolytes from the ion separator directly into the gas generation chambers, thereby, using only two electrolyte tanks 812 and 814, instead of three.

A common output pipe 852 is connected to all the hydrogen output ports of the gas generation chambers. Similarly, another common output pipe 851 is connected to all the oxygen output ports of the gas generation chambers. These common output pipes equalize the pressures in the gas generation chambers thus preventing a situation where extremely higher pressures are produced in gas generation chambers at earlier stages of discharge while other gas generation chambers at latter stages have much lower pressures.

The pumps that circulate the electrolytes in the containerized hydrogen and oxygen production cell 900 are built from kits and all the pump heads are insulated from the chassis on which the kits are assembled. This is to prevent short circuiting the electrolytes going through the pump heads which might cause hydrogen and oxygen gases to be generated inside the pump heads. Insulating the pump heads ensures that gases are only generated inside the gas generation chambers which are designed to handle a mixture of electrolytes and gases. The electrolyte pumps are all ganged together into a first set of pumps and are driven by one motor 830. There is a belt drive from a common shaft connected to the motor 830 to every pump head. These belt drive connections drive all pump heads at the same speed.

FIG. 18 more clearly shows some more components used in the containerized hydrogen and oxygen production cell 900. They include: “pressure-reducing-back-pressure-maintaining valves” placed in the return paths of the discharged electrolytes going back into tanks 812 and 814. One such valve is labeled 862. A pressure release valve 872 is located on the common output pipe 852 of the gas generation chambers. Another pressure release valve is also located on the common output pipe 851 of the gas generation chambers. The water that replenishes the tanks 812 and 814 of the containerized hydrogen and oxygen production cell 900 enters through pipe 880 and its flowrate is controlled by flowmeter 884.

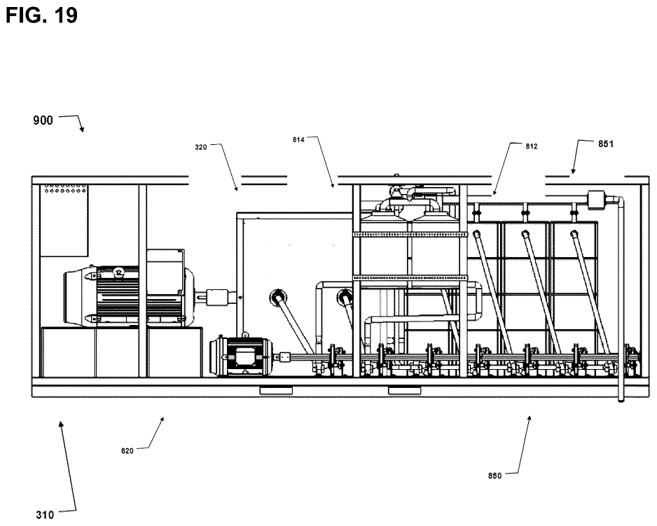

FIG. 19 shows an opposite side of the containerized hydrogen and oxygen production cell 900 where oxygen is produced, we call this the oxygen side. Pumps that circulate electrolytes on the oxygen side are ganged together with pumps that feed electrolytes into the ion separator. Another motor 820 drives this second set of ganged pumps. The motors (820 and 830) of both sets of ganged pumps are driven by one adjustable speed drive. And this adjustable speed drive controls the power requirements of the containerized hydrogen and oxygen production cell 900 by the rate at which it pumps electrolytes through the containerized hydrogen and oxygen production cell 900 for processing. A faster speed leads to higher flow rate of electrolytes into the ion separator resulting in higher power usage by all motors and eventually, higher output rates of hydrogen and oxygen production. A slower speed would produce the opposite effect. This feature can be used to control the total power required by any number of containerized hydrogen and oxygen production cells 900 operating in parallel in a factory. A total factory load could be made to follow the available generated power by using the latter to determine the pumping rates of all the ganged pumps. This would be ideal for following power generation from renewable energy sources by adjusting the factory load to match the available power—all done in real time.

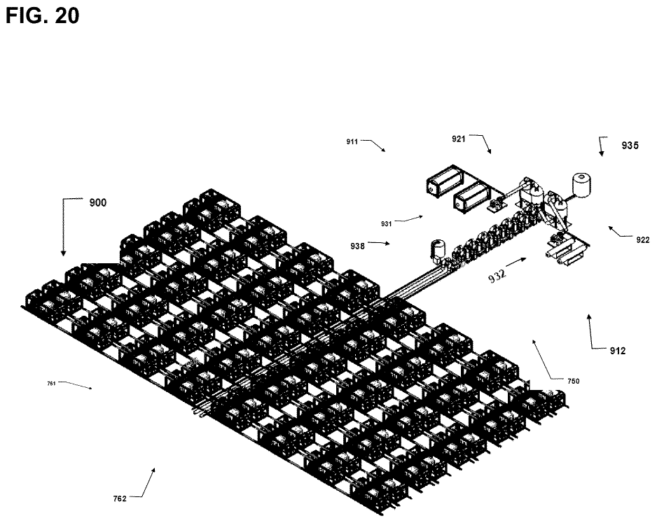

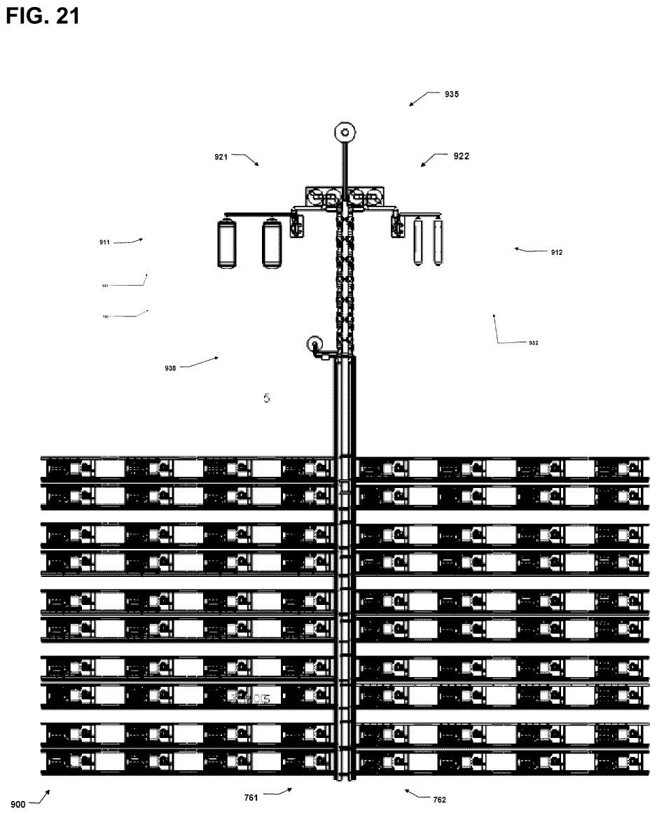

FIG. 20 and FIG. 21 show a layout of a hydrogen and oxygen manufacturing plant. FIG. 20 shows a perspective view and FIG. 21 shows a top view of the plant layout featuring many containerized hydrogen and oxygen production cells, 900.

Two large pipes run in the middle of the floor in the y-direction. A large left pipe 761 carries oxygen and a large right pipe 762 carries hydrogen. Several containerized hydrogen and oxygen production cells 900 are placed in-line in the x-direction on both the left side and the right side of the two large pipes with their common output pipes 852 connected to hydrogen feeder pipes on both sides of the two large pipes. The hydrogen feeder pipes send the hydrogen produced into the large right pipe 762. Special pigtail connectors are used to connect the hydrogen feeder pipes to the large right pipe 762. This is done from both sides of the two large pipes. A similar connection scheme is implemented for the oxygen sides (of the containerized hydrogen and oxygen production cells 900) involving the common output pipes 851, oxygen feeder pipes and the large left pipe 761. This forms the first row of the factory floor. Arrays of these connections are built along the length of the two large pipes to form other rows and result in an x-y grid of containerized hydrogen and oxygen production cells 900, with all the hydrogen feeder pipes sending the hydrogen gas generated into the large right pipe 762 and the oxygen feeder pipes sending the oxygen gas generated into the large left pipe 761. The large left pipe 761 and the large right pipe 762 send their gases through the scrubbers 750. Scrubbed hydrogen gas goes through dryer 922, compressor 932 and is then packaged into a hydrogen cylinder 912. Scrubbed oxygen gas goes through dryer 921, compressor 931 and is then packaged into oxygen cylinder 911.

Two adjacent containerized hydrogen and oxygen production cells 900 are placed very close to each other to enhance the utilization of factory floor space. The plant floor layout can be expanded to produce more hydrogen and oxygen by increasing the number of rows and columns. The capacity of the layout is also scalable by increasing the sizes and capacities of the factory floor components. The water for scrubbing and replenishing the tanks on the containerized hydrogen and oxygen production cells 900 comes from tank 935 and the water is first used in scrubbing the gases and then stored in tank 938 from which it is pumped to the containerized hydrogen and oxygen production cells 900 on the factory floor.

What is claimed is:

1. An x-y laid-out plant, built with hydrogen and oxygen production cells comprising ion separators, electrolyte tanks, pumps, electrolyte pipes, gas generation chambers, hydrogen hoses, oxygen hoses, hydrogen feeder pipes, and oxygen feeder pipes, and utilizing these components to produce hydrogen and oxygen by sending electrolyte into an ion separator to produce positively charged electrolyte stream and negatively charged electrolyte stream and then pumping the positively charged electrolyte stream through a first set of a number of gas generation chambers and simultaneously pumping the negatively charged electrolyte stream through a second set of the same number of gas generation chambers, with each gas generation chamber in the first set paired with and electrically connected to another gas generation chamber in the second set, resulting in hydrogen generation from the gas generation chambers carrying positively charged electrolyte and oxygen generation from the gas generation chambers carrying the negatively charged electrolyte, and sending the hydrogen into hydrogen feeder pipes, and the oxygen into oxygen feeder pipes; the feeder pipes are oriented in the x-direction and they send the hydrogen and oxygen to two large pipes oriented in the y-direction with one large pipe carrying hydrogen and the other large pipe carrying oxygen into two separate scrubbers, one for the hydrogen, and the other for the oxygen, and thereafter send the scrubbed gases into two separate dryers, one for hydrogen and the other for oxygen, and then to a reciprocating compressor for the hydrogen, and another compressor for oxygen; and finally to packaging into an appropriate cylinder for hydrogen storage and another appropriate cylinder for oxygen storage.

2. The ion separator of claim 1, in which structures are attached to magnetic poles to make the structures bear the weight of the magnetic poles and prevent the stator cylinder from bearing the weight of the magnetic poles.

3. The ion separator of claim 1, in which bolting together the structures attached to the magnetic poles prevents the magnetic poles from flying apart or disengaging from the stator cylinder when a magnetic field is energized.

4. The ion separator of claim 1, in which the structures attached to the magnetic poles are well spaced to make ports built into the stator cylinder accessible for hose connections.

5. The gas generation chamber of claim 1, in which inner parts of the gas generation chamber are built with arrays of perforated stainless steel sheet metal to allow easy flow and spreading of electrolyte and, the formation and bubbling, of gases.

6. The gas generation chamber of claim 1, in which charged electrolyte input into the gas generation chamber is through a pipe near a bottom of the gas generation chamber and an electrolyte exit spout is near a top portion allowing much chance for the charged electrolyte to discharge as it spreads and flows through arrays of perforated sheet metal on its way to the exit spout.

7. The gas generation chamber of claim 1, in which a polymer tube is used to carry the exiting electrolyte to prevent contact between the exiting electrolyte and the metal of the gas generation chamber and thus prevent generation of gases in the exiting electrolyte.

8. The gas generation chamber of claim 1, in which a U-bend in a polymer tube of the gas generation chamber prevents gas bubbles from going all the way down after entering an inlet portion of the polymer tube that is filled with electrolyte and, thereby, preventing the gas from escaping through the tube.

9. The gas generation chambers of claim 1, which can be used to lengthen the discharging time of the electrolyte by using multiple gas generation chambers in series to lengthen the contact time with the electrolyte and thereby result in higher levels of discharge.

10. The scrubbers of claim 1, in which an input pipe carrying gas into the scrubber is capped with a perforated cup.

11. The scrubbers of claim 1, in which the perforated cup causes the gas flowing through it to form streams of bubbles that rise through the water used for scrubbing the gas.

12. The scrubbers of claim 1, in which the bubbles rising through the scrubber break and form new bubbles as they go through other perforated sheet metal as they rise upwards.

13. The scrubbers of claim 1, in which cleaner water being introduced into a scrubber chamber is delivered to a top portion of the scrubber chamber and dirtier water being removed from the scrubber chamber is drawn near a bottom portion of the scrubber chamber.

14. The scrubbers of claim 1, in which distilled water is used to scrub droplets and mists of electrolytes from the gas and then use the same scrubbing water to replenish the main electrolyte tank thus capturing and returning the escaping electrolytes for use.

15. The laid-out plant of claim 1, in which hydrogen and oxygen production cells are arranged in x-y grid for ease of expansion, and have scalability based on and component sizing.

16. The gas generation chambers of claim 1, whereby two gas generation chambers are built back-to-back on the same baseplate and are permanently short circuited.

17. The hydrogen and oxygen production cells of claim 1, in which the hydrogen and oxygen production cell is built with ganged pump heads driven at the same speed and the hydrogen and oxygen production cell is containerized.

18. The pumps of claim 1 in which the pumps are built with kits and the pump heads are insulated from the chassis on which they are assembled to prevent short circuiting the pump heads and causing gas generation in the pump heads.

19. The hydrogen and oxygen production cells of claim 1, in which two tanks are used for supplying electrolytes for the input ports.
